(19) United States
(12) Patent Application Publication
(10) Pub. No.: US 2021/0323198 A1
(43) Pub. Date: Oct. 21, 2021

(54) Method and Apparatus for Recycling Post-Consumer Plastic Waste

(71) Applicants: Aldrin Lupisan, Long Beach, CA (US); William Amos, Long Beach, CA (US); Sharon To, Long Beach, CA (US)

(72) Inventors: Aldrin Lupisan, Long Beach, CA (US); William Amos, Long Beach, CA (US); Sharon To, Long Beach, CA (US)

(21) Appl. No.: 17/234,500

(22) Filed: Apr. 19, 2021

Related U.S. Application Data
(60) Provisional application No. 63/013,110, filed on Apr. 21, 2020.

(51) Int. Cl. B29B 17/02; B29C 64/357; B29B 11/10

(52) U.S. Cl. CPC B29B 17/02; B29B 2017/0015; B29B 11/10; B29C 64/357

(57) ABSTRACT

A method of recycling post-consumer plastic waste into mono filament for use in fused filament fabrication, injection molding, or other plastic manufacturing processes. Contaminated curbside plastic waste is sorted and granulated to uniform sized flakes. The plastic regrind is cleaned in a closed-loop wash cycle and dried at 160° F. and −70 dew point to reduce the moisture content to less than 0.03%. The effluent water is purified to be reused in the system. The flake plastic is extruded to a molten state and passes through additional melt filtration. A laser micrometer measures extrudate metrics like diameter and ovality to dynamically control feed and flow rates of the extruder to maintain diameter uniformity within 0.018 mm of target diameter.

### CROSS REFERENCE TO RELATED APPLICATIONS

This application claims the benefit of filing date priority of U.S. Patent Application No. 63/013,110, filed on Apr. 21, 2020.

### FEDERALLY SPONSORED RESEARCH

Not applicable

### REFERENCE TO A MICRO FICHE APPENDIX

Not applicable

### BACKGROUND OF INVENTION

### Field of Invention

This invention relates to plastic recycling and and plastic manufacturing processes and more specifically relates to a plastic recycling system that processes post-consumer plastic waste into uniform structural mono filament to be used in plastic additive manufacturing.

### Description of the Related Art

Plastic extrusion systems are commonly used by existing plastic manufacturers that produce plastic mono filament. Current plastic manufacturers intake new plastic material in a uniform pelletized form factor and melt the material through their extruder to produce the mono filament made out of previously unprocessed plastic resin. Conventional extrusion systems are not capable of processing post-consumer and contaminated plastic waste. Post-consumer plastic waste as a feedstock is inherently non-uniform as it is sourced from municipalities whose constituents utilize materials from any number of producers. Since the waste also comes from waste sorting facilities the feedstock also contains non-trivial amounts of non-plastic contamination that consists of material ranging from but not limited to dirt, debris, glass, metal, and organic material.

Specifically pertaining to the extrusion process, conventional extruders rely on feedstock consistency to dictate the uniformity of the output extrudate. Conventional extruders typically operate at a single flow and feed rate that is predetermined before the extrusion process begins and remains running at the same rate until the process ends. Granulated waste plastic consists of flakes with a size variation of roughly 0.1 mm to 2 mm, which is not suitable feedstock for current extrusion systems. Because of the fluctuation in material flow and pressure that is caused by the size inconsistencies, conventional extruders will produce low-quality mono filament with a high variance in diameter. Additionally, any trace of contaminant in the extruder feedstock will likely cause clogging issues due to insufficient material screening and filtering processes in traditional extrusion.

Specifically pertaining to the current recycling infrastructure, existing recycling systems do not process post-consumer plastic waste due to factors such as technological barriers in which existing technology is not equipped to process inconsistent and contaminated material. Additionally, a lack of resources prevents current recyclers from investment in further developing the recycling infrastructure to enable proper handling of post-consumer plastic. Conventional recyclers focus primarily on sorting of plastics to be sold on the scrap plastic market rather than actual processing of said material.

In these respects, the process of this present invention fulfills a unique need for a system that accepts contaminated post-consumer plastic waste and produces reliable and structural plastic mono filament that can be reused in downstream plastic manufacturing processes. Additionally, this invention serves as a proof of concept and creates a pathway for utilizing post-consumer plastic material as useful feedstock material, which can therefore encourage further recycling infrastructure development.

### BRIEF SUMMARY OF THE INVENTION

In view of the shortcomings of existing recycling and extrusion technology, the present invention is uniquely positioned to efficiently process post-consumer plastic material, that would otherwise be land filled, into reliable additive manufacturing feedstock with properties and performance characteristics comparable to their raw material equivalents.

The general purpose of this invention is to provide a closed-loop methodology for recycling post-consumer plastic material to be used as direct substitution for existing raw materials currently used in additive manufacturing to reduce the reliance on crude oil for producing more plastic resin as well as to reduce the volume of plastic waste that is currently being land filled and causing plastic pollution.

A combination of manual sorting, filtered granulation, gravity separation, washing, and mesh sifting eliminate contaminants and impurities from the input material throughout several steps in the recycling process. The effluent water produced from the system is further purified and reintroduced into the system to supply the other water-reliant processes, such as the washing, drying, and extrusion steps, thereby creating an additional closed-loop water management system. The cleaned and reground plastic material that feeds into the extrusion machine passes through additional melt filtration in its molten state to remove additional micro-contaminants, resulting in a purified extrudate that is monitored by an active programmable control logic mechanism that utilizes the extrudate's diameter to dynamically adjust the rate at which the extruder produces filament as well as the rate at which the belt puller pulls the material onto a spindle through a winder.

An object of the present invention is to provide a methodology and means for recycling heavily contaminated post-consumer plastic waste material that is currently being land filled due to the shortcomings of existing recycling infrastructure.

Another object of the invention is to produce uniform plastic mono filament from non-uniform plastic regrind using an integration of software technology with industrial hardware to alter conventional extrusion in order to accommodate for variance in quality or properties of the feedstock material.

Another object is to provide a system that utilizes its own closed-loop water management system that filters and repurposes effluent water in order to reduce water consumption of recycling and extrusion processes and eliminate industrial waste water typically produced in manufacturing.

### BRIEF DESCRIPTION OF THE DRAWINGS

FIG. 1 is a block diagram of the present invention.

FIGS. 2A and 2B are flowcharts illustrating the overall process of the present invention.

FIG. 3 is a flowchart that illustrates the granulation process of input waste material.

FIG. 4A is a flowchart illustrating the methodology of the eddy current separator.

FIG. 4B is a block diagram of the material movement in the eddy current separator.

FIG. 5A is a block diagram illustrating the primary material dust removal in the gravity separation process.

FIG. 5B is a block diagram illustrating the secondary material stratification in the gravity separation process.

FIG. 6 is a flowchart illustrating the wash cycle process.

FIG. 7 is a flowchart illustrating the steps involved in the material drying process.

FIG. 8 is a flowchart illustrating the sifting process of the clean and dry flake material.

FIG. 9 is a block diagram that illustrates the components involved in the extrusion process, the movement of plastic through the system, and the data transfer that controls the system.

FIGS. 10A and 10B are flowcharts illustrating the diameter monitoring and control system of the invention.

### DETAILED DESCRIPTION OF THE INVENTION

### Overview

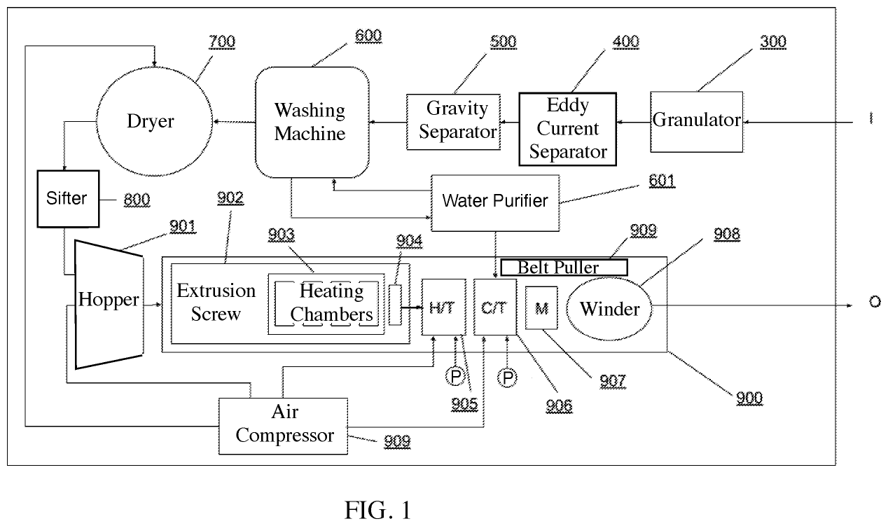

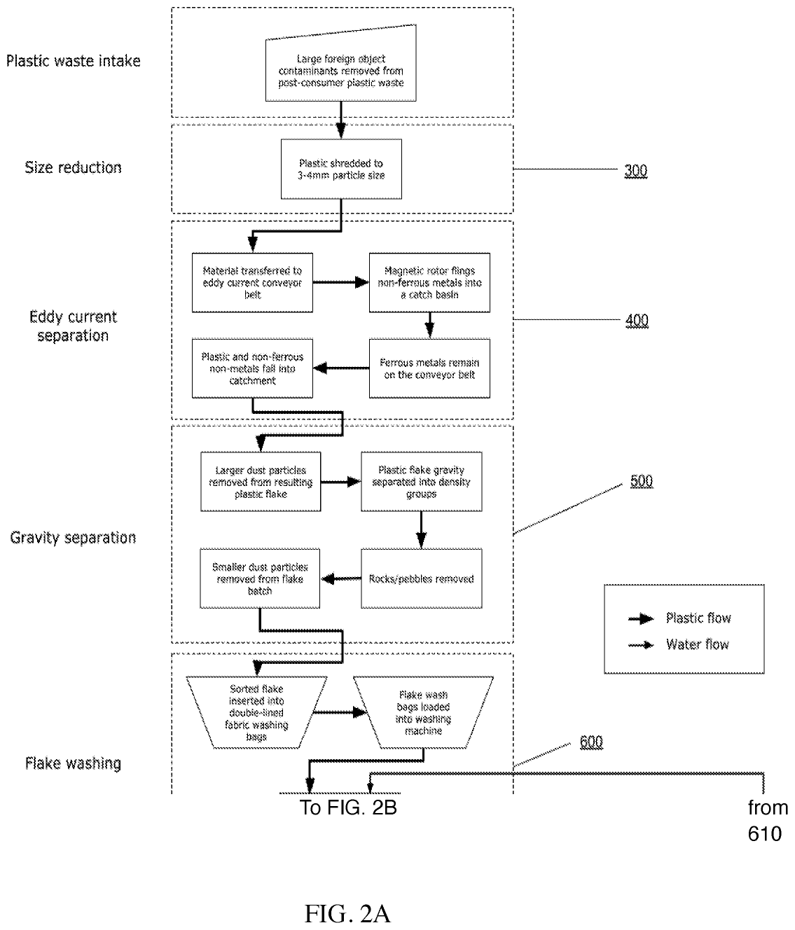

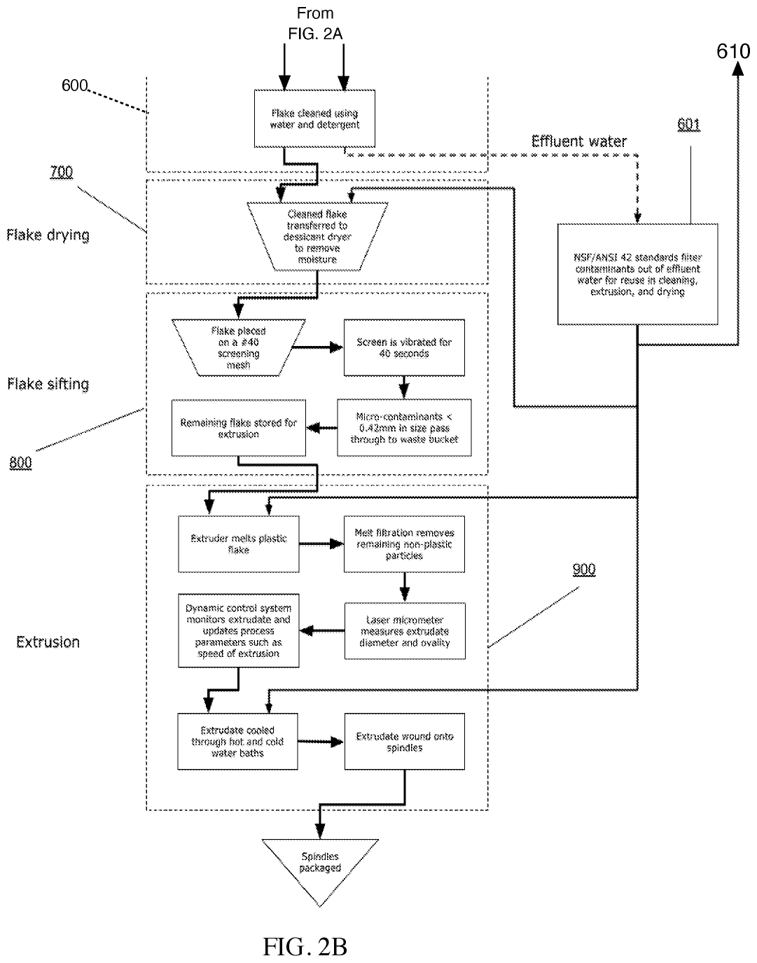

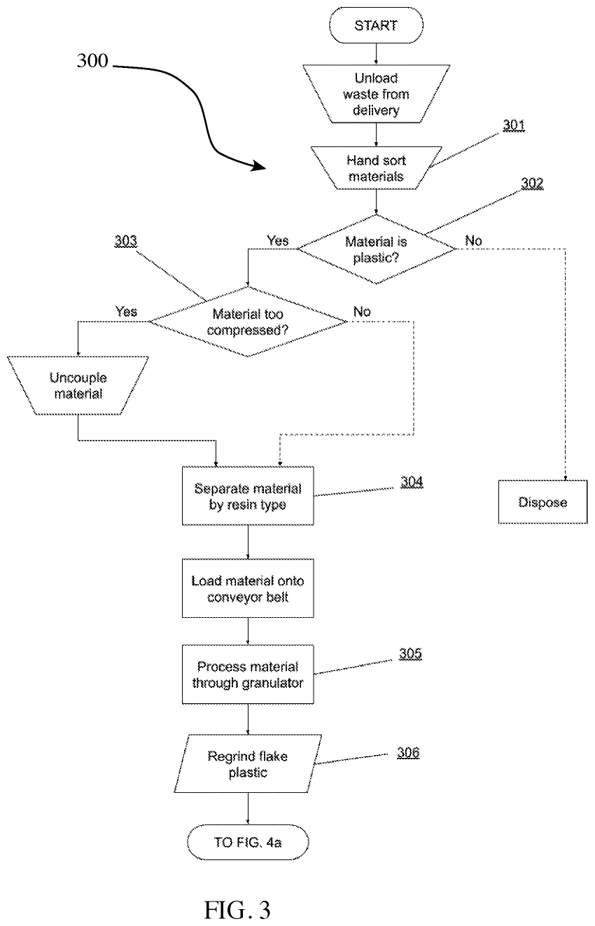

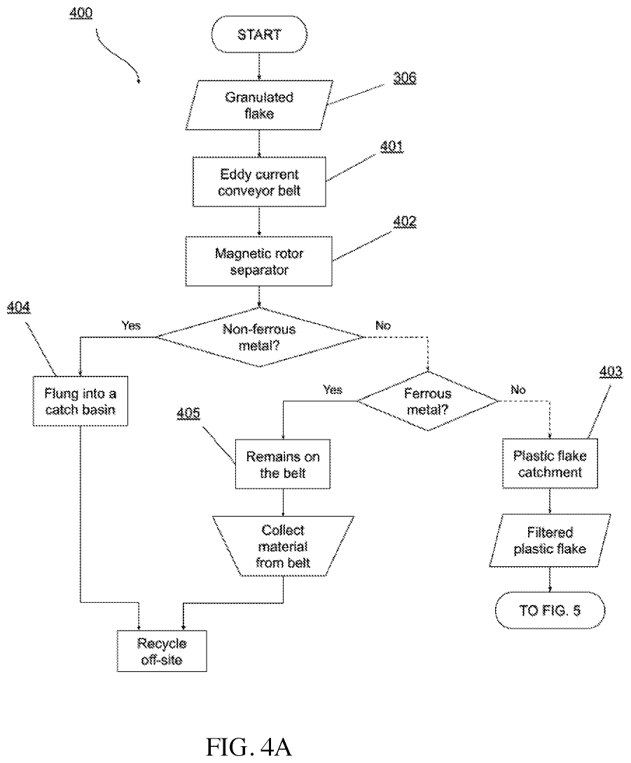

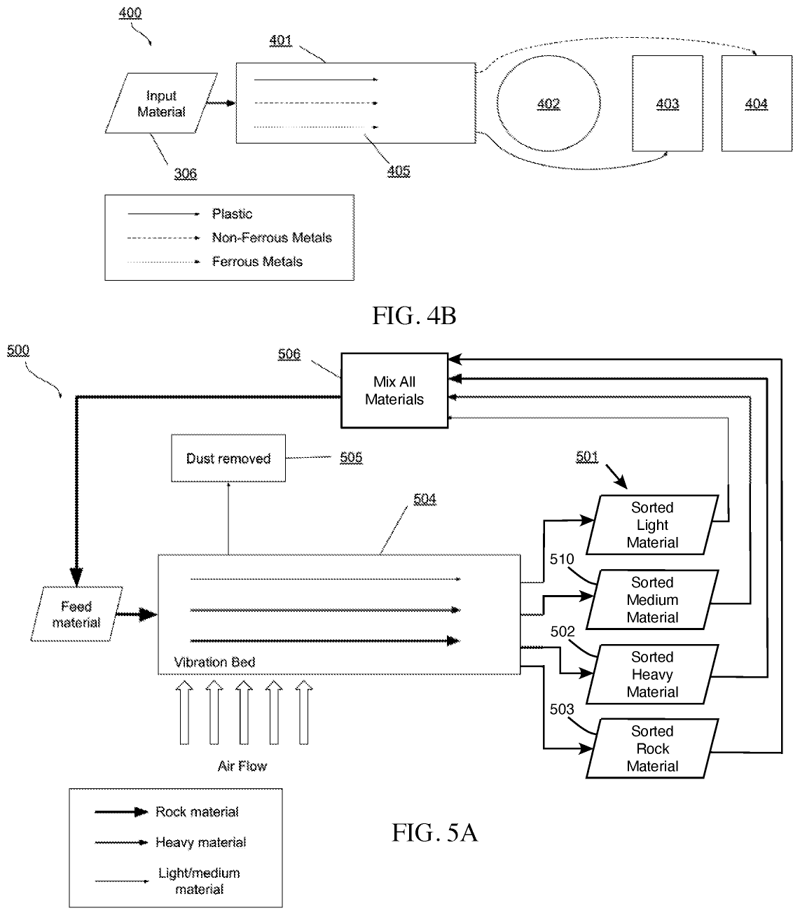

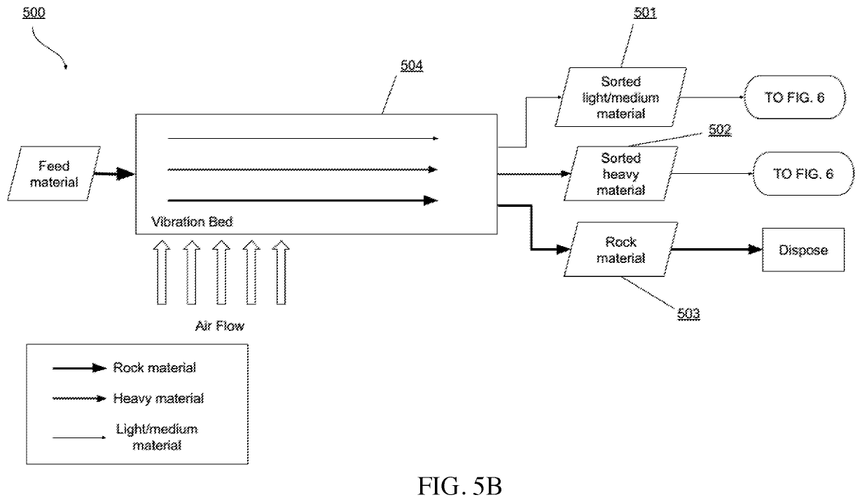

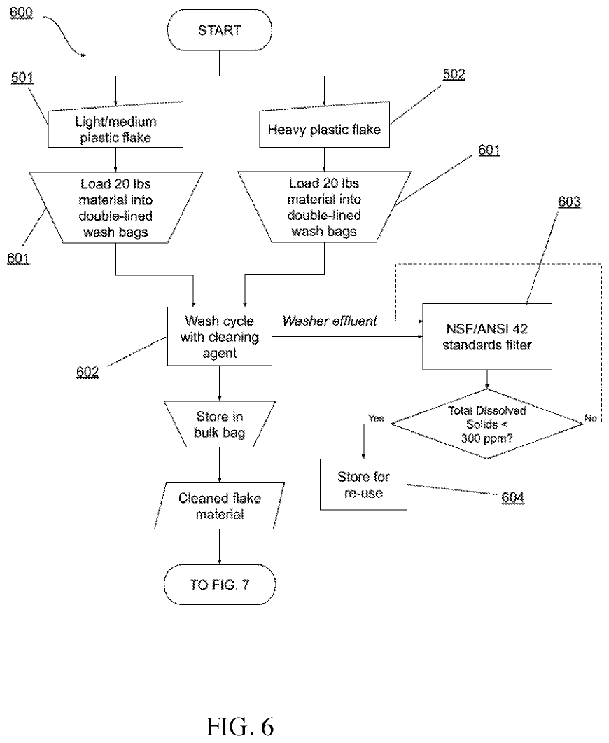

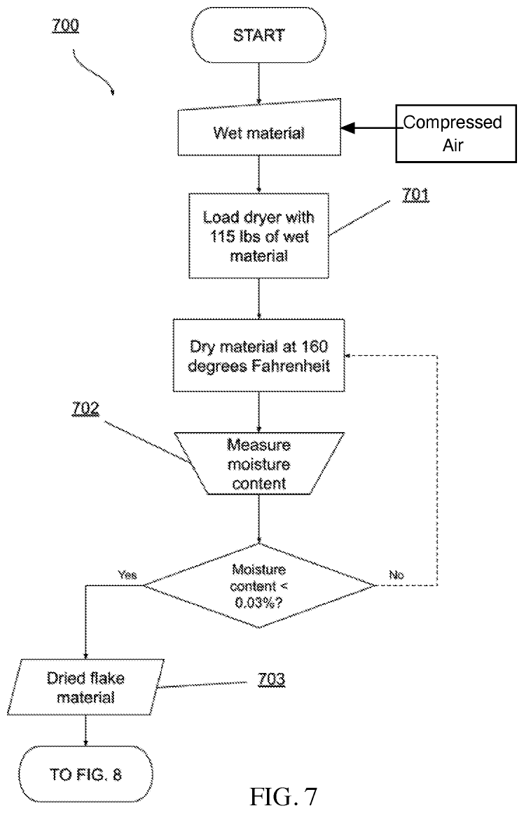

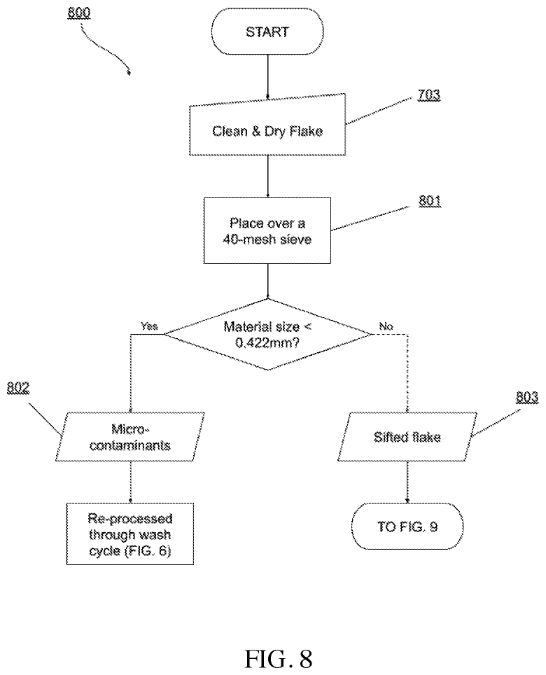

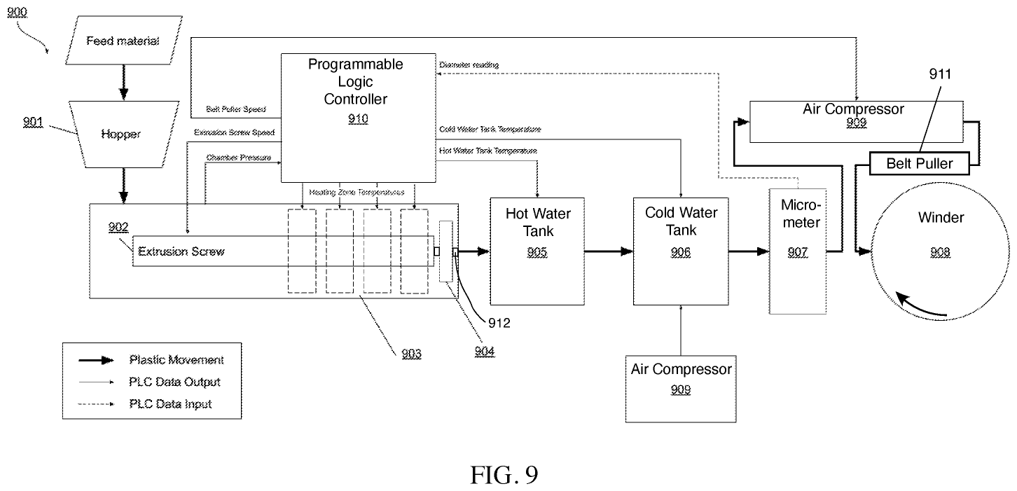

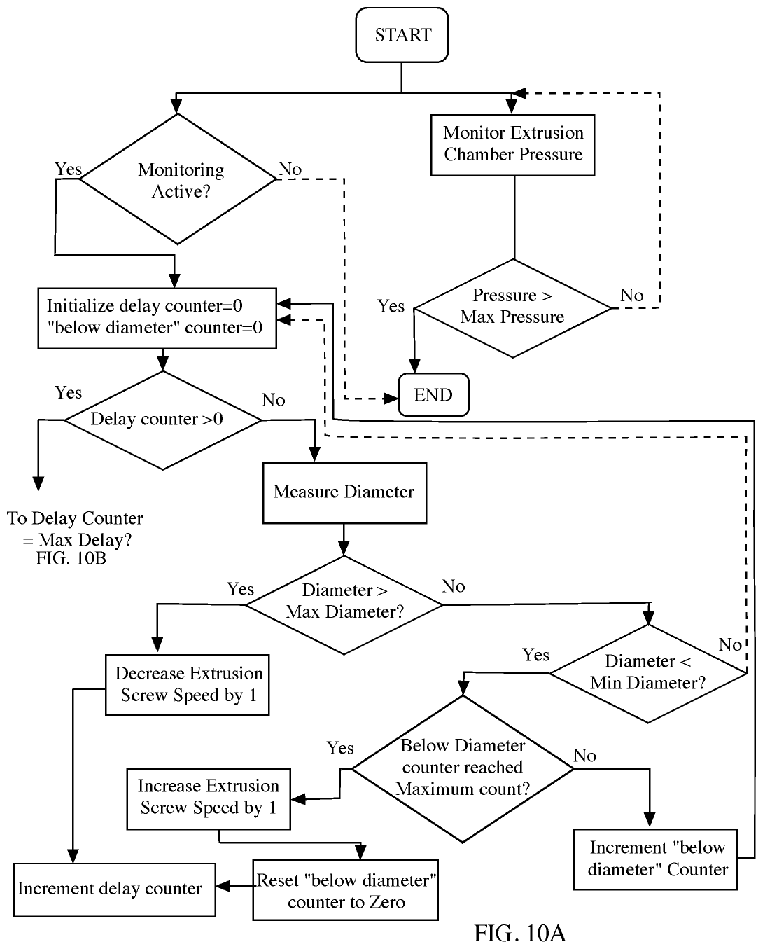

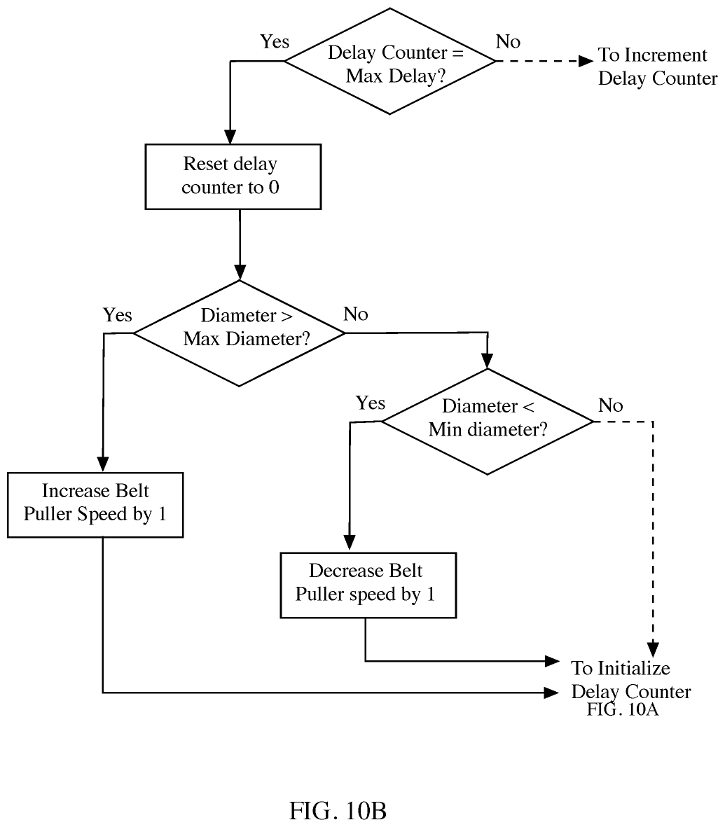

The following detailed description of the invention details with accompanying drawings are not intended to limit the scope of the invention, but rather illustrate the preferred embodiment of the invention. FIGS. 1-2A and 2B illustrate the recycling and extrusion system which comprises the granulation step; FIG. 3 that initiates the recycling process, eddy current separation FIG. 4A-4B and gravity separation FIG. 5A-5B for filtering, the washing mechanism FIG. 6 that cleans the material and repurposes the effluent water, the drying phase FIG. 7 that removes all excess moisture from the material, the sifting phase FIG. 8 that further decontaminates and homogenizes the material, and the final extrusion step FIG. 9 that melts the material into its final form factor as mono filament in accordance to the programmable logic control process. FIGS. 10A and 10B depict the system for controlling the diameter of the extrudate to produce consistent and uniform material.

### Granulation

The granulation step 300 utilizes a conveyor belt to transfer material into a granulator with a wide hopper to receive material that is then reduced in size into reground flake material. The granulator may comprise a staggered blade screened granulator, generally known in the industrial arts, that receives the material from the hopper discharge port. The granulator may typically include sharp blades extending from a rotating shaft and arrayed therealong in staggered, angularly offset fashion. As ground material is shredded sufficiently it falls through a mesh screen and into a downward chute leading to a bin that holds the flake material. FIG. 3 illustrates the process workflow of granulating waste material. An initial hand sorting stage 301 removes immediately identifiable and large pieces of contamination from the feed material. Any material that is deemed contamination either because it is organic material or it is non-plastic, such as metal or glass, is disposed of 302. Material may also be in a highly compressed form 303 such that the material is not easily pulled apart through the hand sorting process. These compressed pieces of material are uncoupled separately and returned to the feed material for granulation. This stage also segregates material by plastic resin type 304 in accordance with the ASTM International Resin Identification Coding System. In all subsequent stages material is processed in batches by resin type. The hand sorted material is conveyed into a granulator 305 that is fitted with a 4 mm size mesh screen, but may be fitted with any size mesh in adherence to the desired output size of regrind material 306.

### Eddy Current Separation

The granulated flake material 306 resulting from granulation step 300 is filtered through an eddy current separation mechanism 400 (FIG. 2A) to remove additional metals and contaminants that were not manually removed. FIG. 4A illustrates the process workflow of the eddy current separation, and FIG. 4B provides a schematic illustration of the material movement through the eddy current separator. The eddy current conveyor belt 401 moves the material past a magnetic rotor 402 which comprises of magnets rotating such that a magnetic eddy current is generated around non-ferrous metals, such as aluminum, that allow them to be launched into an isolated container for disposal 404 and separated from the non-metal material that is captured in a non-metals container 403 for further processing. Ferrous metals remain on the conveyor belt 405 and are manually collected from the belt for disposal.

### Gravity Separation

Gravity separation 500 eliminates coarse non-plastic material that comprises but is not limited to sand, food waste, and powder residue. The gravity separation phase constitutes two stages of gravity separation. FIG. 5A illustrates the primary separation process in which dust removal is the key objective. The feed material from the eddy current separation 400 is transferred to the gravity separator vibration bed 504 where the material is agitated using vibrations and air flow to separate the flake material by density. The material is split into four categories based on their density known as light material 501, medium material 510, heavy material 502, and rock material 503 where each category represents increasingly denser material respectively. Additionally, the gravity separator comprises its own dust collection system 505 that removes fine particulate matter. Once separated into the four density classes, the material is mixed back together 506 and fed back into the gravity separator to commence the secondary separation process. Proper mixing of all four density classes is important to the second phase as it is essential to achieve proper bulk density stratification.

FIG. 5B illustrates the secondary phase of gravity separation wherein the key objective is stratification. The mixed flake is fed back onto the gravity separator vibration bed 504 and separated using the same means as in the primary separation using vibrations and air flow. The material is again separated by density classes consisting of light material 501, medium material 510, heavy material 502, and rock material 503. At the conclusion of the secondary phase, the rock material 503 is disposed of and the light 501, medium 510, and heavy 502 materials are processed as separate product streams in the remaining stages.

### Washing

Stratified material 501-502 resulting from the secondary gravity separation step illustrated in FIG. 5B is washed to remove wet fine dust particles of sizes roughly greater than 0.005 mm 600 as illustrated in FIG. 6. The material is loaded into double-lined porous fabric wash bags 601 that can retain the flake plastic while allowing for water and detergent to remove the contaminants. The wash bags are then cleaned through a single wash cycle using water and a cleaning agent 602. Additionally, the effluent from the washer that consists of water, detergent, and any other fine particle contamination undergoes a filtration process 603. This includes advanced filtration using NSF/ANSI 42 standards and a media that filters out contaminants down to 0.005 mm. The filtered effluent water is measured to ensure that the Total Dissolved Solids (TDS) is less than 300 parts per million. The resulting filtered water can then be reutilized for other processes 604 including: cooling for the drying and extrusion process, and further washing of subsequent plastic, ensuring that the system's impact on water supply is reduced significantly, in the range of 50% or more.

### Drying

FIG. 7 illustrates the drying step 700 which removes surface water and moisture content from the wet and cleaned flake material. The air compressor 908 (FIG. 9A) delivers compressed air that is utilized to convey the wet flake material 604 into a desiccant dryer 701. Material is dried to a moisture content of less than approximately 0.03% using variable drying parameters such as the drying temperature and drying session time, which may be varied in accordance with the material type. In one example, the material comprises HIPS, and is dried at 160° F. for eight hours before the material is measured using a moisture meter 702 to ensure that the flake material's moisture content is less than 0.03%. Material dryness is essential to preventing steam build-up during the extrusion phase 900 which would otherwise result in air bubbles, inconsistent extrusion, and other material issues.

### Sifting

Dry flake material 703 is further sifted for final removal of loosened micro-contaminants that were dislodged from the flake during the washing 600 and drying 700 processes. FIG. 8 illustrates a process flowchart of the sifting phase. Using an industry standard #40 screening mesh 801, flake material on top of the mesh is agitated so that micro-contaminants smaller than the mesh screen sieve fall through into a waste container 802. The remaining flake that sits above the screen 803 is the final batch of decontaminated flake plastic.

### Extrusion

The extrusion process 900 illustrated in FIG. 9 contains several components such as the hopper 901 which is a wide mouthed container that holds the material to be extruded; the extrusion screw 902 whose length spans from the bottom of the hopper 901 through the four heating zones 903 and ends at the extruder nozzle 912 where molten material exits the heating chambers; a hot water tank 905 followed by a cold water tank 906 that are used to cool the material in a uniform manner; an air compressor 909 that provides the air needed for the air wipe at the conclusion of the water tanks to dry the material; a micrometer 907 that measures properties of the output mono filament and relays measured data to the programmable logic controller 910 that then determines the behavior of the extruder and belt puller 911 based on the observed data; the belt puller 911 being arranged to receive the material from the extruder nozzle, and a winder 908 that receives the newly formed mono filament from the belt puller 911 and spools the mono filament onto a spindle to store the mono filament for future use.

Prior to operating the extruder, several components need to be primed for efficient operation such as the four heating zones 903, the hot water tank 905, and the cold water tank 906. Each heating zone 903 is set to a specific temperature based on the heat pro file of the material being processed. Unique heat pro files are determined based on the material melt temperature. The temperature of the hot water tank 905 and cold water tank 906 are additionally determined based on the material melt temperature such that when the material enters into the water bath the temperature differential does not cause the material's shape to deform.

Material is fed into the extruder's hopper 901 using a flood feeding strategy, in which the material is fed into the hopper to a certain capacity, or a starve feeding strategy, in which the material is fed into the hopper at a metered rate such that the hopper does not accumulate material. The particular method of loading material into the hopper is largely dependent upon material properties.

The programmable logic controller (PLC) 910 is used to determine the initial speed at which the extrusion screw 902 revolves and therefore the speed at which material is moved through the extruder. The overall throughput is additionally impacted by the speed at which the belt puller 911 pulls the material onto a spindle, which is also controlled by the PLC 910. The rotation of the extrusion screw 902 in combination with the heat from the heating zones 903 melt, compress, and compound the material such that a single thread of compact mono filament is formed. The extrudate material is filtered through a mesh screen pack 904 consisting of multiple layers of mesh screens of varying grades for a final filtration of decontaminants before exiting the nozzle 912 of the extruder.

The molten extrudate is immediately fed into the hot water tank 905 to initiate the material cooling process. A pump is utilized in the hot water tank 905 to generate movement in the water and distribute the heat from the extrudate evenly in the tank and maintain its equilibrium temperature. The hot water tank 905 precedes the cold water tank 906 where the material is further cooled so that the extrudate material is now hardened mono filament. Similarly to the hot water tank 905, the cold water tank 906 also utilizes a water pump to facilitate distribution of heat and maintain the tank's temperature. An air wipe system powered by the air compressor 909 dries the material of any surface water remaining from the water tanks 905-906.

A laser micrometer 907 measures the diameter and ovality of the resulting mono filament and provides this data to the PLC 910 that then utilizes the input data according to the dynamic control logic illustrated in the flowchart in FIG. 10A-10B to determine in real time how to adjust the extrusion screw 902 rotational speed and belt puller 911 linear speed and the winder rotational speed to ensure that the extrudate exiting the nozzle 912 is of the desired diameter and ovality in a consistent manner. Due to the inherent inconsistencies of flake material and continued presence of contaminants despite multiple layers of complex filtering, the melting process of the plastics may result in irregular material flow. Maintaining a static extrusion screw 902 speed and belt puller 911 speed would therefore produce a mono filament that has extremely inconsistent diameter with a very large variability, resulting in unusable end-user material. Instead, the PLC 910 employed in this invention ensures continual monitoring and control of the mono filament, so that the final product is uniform in size and shape independent of the consistency of material flow from the extruder.

Given a target diameter, the PLC 910 will accept the diameter read by the micrometer 907 as input data to process. A diameter larger than the target diameter will trigger the PLC 910 to decrease the speed of the extrusion screw 902. After allowing the material behavior to absorb the alteration, the PLC 910 will subsequently decrease the speed of the belt puller 911 to reach equilibrium with the extrusion screw 902. Alternatively, if the diameter is smaller than the target diameter the PLC 910 will increase the speed of the extrusion screw 902, followed by the increasing the speed of the belt puller 911 after the appropriate delay. A diameter matching the desired target diameter will result in no change to the behavior of the extrusion screw 902 or belt puller 911 speeds.

The PLC 910 also monitors the pressure of the extrusion chamber for the entirety of the extrusion process to ensure safety of the equipment and the operators. A maximum operating pressure specification is provided by the equipment manufacturer; the PLC 910 has an automatic fail safe when the machinery reaches 60% of the maximum pressure.

With regard to FIG. 10A-10B, the PLC 910 is programmed to carry out a number of steps to monitor and control the entire process of extrusion of the sifted flake input material. In addition to continually monitoring the pressure in the extrusion chamber 902, the application receives the diameter data from the laser micrometer 907 and compares that reading to minimum and maximum diameter settings, and responds to readings in excess of the desired maximum diameter by decreasing the speed of the extrusion screw, and by increasing the speed of the extrusion screw if the output diameter is below a minimum setting. As shown in FIG. 10B, when the diameter readings are less than or more than the desired limits, a delay counter is invoked to increase the belt puller speed when the maximum diameter has been exceeded, and to decrease the belt puller speed when the minimum diameter limit has been exceeded. Thus the belt puller is driven to match the rate of output of the mono filament from the extruder as the screw speed is changed and the output velocity of the extrudate is correspondingly modified. An unexpected benefit of this control system is that monitoring the diameter of the extrudate of the system in real time enables the control of extruder speed and processing temperatures and results in an output product that is uniform in diameter and density and is suitable for many post-process uses, despite the fact that the input feedstock is not necessarily characterizable to fall within known limits of chemical composition, density, viscosity, and melting point.

Finally, the mono filament is wound onto a spindle by the winder 908. The resulting spool of mono filament can then be used directly for fused filament fabrication (FFF) or optionally further processed into plastic pellets through a pelletizer to meet form factor needs of other forms of plastic manufacturing such as injection molding.

### Conclusion

The invention as described above illustrates the principles of the invention and a preferred embodiment of the invention, but are not meant as limitations. There are many possible variations resulting from potential alterations in sizing, material, and the like made by those skilled in the art.

1. A method for recycling post-consumer plastic waste into fused filament fabrication monofilament for additive manufacturing end users, said method comprising the steps of:
sorting and granulating raw plastic waste;
filtering non-ferrous and ferrous metals from the flake material;
filtering coarse non-plastic material from the flake material;
washing the material;
drying the material;
extruding the material through an extruder having a variable output speed that melts the material and forms said monofilament output;
measuring the diameter of said monofilament as it is discharged from said extruder and varying the output speed of said extruder to maintain the diameter of said monofilament within predetermined minimum and maximum range limits in a dynamic control system.

2. The method for recycling post-consumer plastic waste of claim 1, wherein said step of measuring the diameter of said monofilament includes using a laser micrometer that is directed toward the monofilament as it is discharged from said extruder.

3. The method for recycling post-consumer plastic waste of claim 1, further including a belt puller for receiving said monofilament as it is discharged from said extruder, said belt puller having a variable linear speed.

4. The method for recycling post-consumer plastic waste of claim 3, further including a delay counter system for controlling said variable linear speed of said belt puller to correspond to the discharge rate of said monofilament from said extruder.

5. The method for recycling post-consumer plastic waste of claim 1, wherein said step of filtering ferrous and non-ferrous flake material includes passing the flake material through an eddy current separation apparatus to remove non-plastic contaminants.

6. The method for recycling post-consumer plastic waste of claim 5, further including conveying a stream of said flake material past a magnetic rotor that flings non-ferrous materials out of said stream, and employing magnetic separation to remove ferrous contaminants from said stream.

7. The method for recycling post-consumer plastic waste of claim 1, wherein said step of filtering coarse non-plastic material from the flake material includes a gravity separator having a vibration bed in which the flake material is agitated using vibration and air flow to separate the flake material by density to form four density streams: light material, medium material, heavy material, and rock material.

8. The method for recycling post-consumer plastic waste of claim 7, wherein said rock material is disposed of, and said light, medium, and heavy material are maintained as separate feedstocks.

9. The method for recycling post-consumer plastic waste of claim 8, wherein said step of washing said material includes loading said separate feedstocks into porous fabric wash bags and using water mixed with a cleaning agent to wash said feedstocks in said bags.

10. The method of claim 9, further including the step of purifying and repurposing the washer effluent water.

11. The method for recycling post-consumer plastic waste of claim 9, wherein said drying step includes using compressed air to convey the wet feedstock material into a desiccant dryer.

12. The method for recycling post-consumer plastic waste of claim 11, wherein said feedstock is dried to a moisture content of less than 0.03%.

13. The method for recycling post-consumer plastic waste of claim 11, further including the step of sifting the dried feedstock using a mesh screen sieve to support the dried feedstock and agitate said feedstock simultaneously.

14. The method for recycling post-consumer plastic waste of claim 1, wherein said step of extruding said material includes heating said extruder to a predetermined temperature range and maintaining said extruder within said temperature range.

15. The method for recycling post-consumer plastic waste of claim 14, further including a hot water tank for receiving said monofilament from said extruder and cooling and initially solidifying said monofilament.

16. The method for recycling post-consumer plastic waste of claim 15, further including a cold water tank for receiving said monofilament from said hot water tank and cooling said monofilament to a final solid state form.

17. The method for recycling post-consumer plastic waste of claim 16, wherein said step of washing said material includes using a water solution to wash the material, said water solution being filtered and cleaned for subsequent use in said hot and cold water tanks.

18. The method for recycling post-consumer plastic waste of claim 1, wherein said step of sorting and granulating raw plastic waste includes segregating the raw plastic by type in accordance with ASTM International Resin Identification Coding System.

19. The method for recycling post-consumer plastic waste of claim 3, further including a winder drum for receiving and winding said mono filament, said winder rotating at an angular velocity that matches the linear speed of said belt puller.
